(19) United States
(12) Patent Application Publication
(10) Pub. No.: US 2024/0383458 A1
(43) Pub. Date: Nov. 21, 2024

(54) BRAKING DEVICE, ELECTROMECHANICAL BRAKING SYSTEM, AND METHOD FOR OPERATING AN ELECTROMECHANICAL BRAKING SYSTEM

(71) Applicant: Robert Bosch GmbH, Stuttgart (DE)

(72) Inventors: Andreas Schmidtlein, Tamm (DE); Dimitri Zimanovic, Ostfildern (DE); Fei Xie, Gemmrigheim (DE); Frank Kursawe, Untergruppenbach (DE); Jochen Huebl, Schwieberdingen (DE); Sebastian Illig, Crailsheim (DE); Simeon Lange, Mundelsheim (DE)

(21) Appl. No.: 18/695,733

(22) PCT Filed: Mar. 2, 2023
(86) PCT No.: PCT/EP2023/055307

§ 371 Date: Mar. 26, 2024

(30) Foreign Application Priority Data
May 13, 2022 (DE) 10 2022 204 709.5

(51) Int. Cl. B60T 8/32; B60T 8/171; B60T 8/172; B60T 13/74; F16D 65/18; F16D 121/24; H02P 3/06

(52) U.S. Cl. CPC B60T 8/321; B60T 8/171; B60T 8/172; B60T 13/746; F16D 65/18; H02P 3/06; B60T 2240/00; F16D 2121/24

(57) ABSTRACT

An electromechanical braking system. The force required for the braking process is provided by an asynchronous machine. The asynchronous machine and the torque delivered by the asynchronous machine is adjusted using a quasi-stationary rotor position for the rotor of the asynchronous machine.

### FIELD

The present invention relates to a braking device and to an electromechanical braking system having such a braking device. The present invention also relates to a method for operating an electromechanical braking system.

### BACKGROUND INFORMATION

Motor vehicles have a braking system which can brake the wheels of the vehicle in order to brake or decelerate motor vehicles. At present, hydraulic braking systems are predominantly used for this purpose. In addition, electromechanical braking systems are also increasingly used.

PCT Patent Application No. WO 2000/29268 A1 describes, for example, an electrically actuatable parking brake system.

### SUMMARY

The present invention provides a braking device and an electromechanical braking system and a method for operating an electromechanical braking system. Advantageous embodiments of the present invention are disclosed herein.

According to an example embodiment of the present invention, the following is provided:

A braking device having a braking element, a transmission, an asynchronous machine, and a control device. The braking element is designed to exert a force on a brake pad. In particular, the brake pad can be pressed against a brake disc when the force is exerted on the brake pad. The transmission is designed to mechanically couple a drive shaft of the asynchronous machine to the braking element. The control device is designed to control the asynchronous machine. In particular, the control device can control the asynchronous machine using a quasi-stationary rotor position. In other words, when controlling the asynchronous machine, the control device starts from an at least approximately constant rotor position.

Furthermore, the following is provided according to an example embodiment of the present invention:

An electromechanical braking system having a braking device according to the present invention, a brake disc, and at least one brake pad. The at least one brake pad is designed here to be pressed against the brake disc by the braking device.

The following is also provided according to an example embodiment of the present invention:

A method for operating an electromechanical braking system, in particular an electromechanical braking system which is controlled by an asynchronous machine. The method comprises a step for receiving a setpoint value for a braking force to be adjusted. Furthermore, the method comprises a step for controlling the asynchronous machine. In particular, the asynchronous machine can be controlled using the received setpoint value for the braking force to be adjusted and a quasi-stationary rotor position of the asynchronous machine.

The present invention is based on the finding that an electrical drive is required to actuate an electromechanical brake. In this case, brushless motors, in particular permanently excited synchronous machines, are preferably used in electromechanical braking systems.

However, the operation of such requires synchronous machines in a quasi-static state, or at a low rotational speed necessarily requires ascertaining a rotor position, for example by means of an additional rotor position sensor.

It is now a concept of the present invention to take this finding into account and to create a drive which is as simple and robust as possible for an electromechanical braking system.

In particular, an electromechanical braking system is intended to be created which can be driven by a robust electrical machine without a rotor position sensor.

For this purpose, it is provided according to an example embodiment of the present invention for the electromechanical braking system to be driven by means of an asynchronous machine. Due to the relatively small movements of the braking elements, in particular of the brake pads, during a braking process, it can be assumed that the rotor of such an asynchronous machine performs only a very small rotational movement during the braking process. Correspondingly, an at least approximately constant rotor position can be assumed for controlling the asynchronous machine. The asynchronous machine can thus also be controlled without an additional rotor position sensor for ascertaining a rotational movement of the rotor of the asynchronous machine.

According to an example embodiment of the present invention, to control an asynchronous machine, it is sufficient to set the frequency of the phase voltages on the asynchronous machine on the basis of the so-called slip, i.e., the speed difference between the rotor and the rotating magnetic field. Here, the resulting torque is proportional to the magnetic flux and the slip.

As explained above, only very small movements are required to actuate an electromechanical brake. Accordingly, the rotational movement in the rotor of the electric machine is also only very small. The torque to be adjusted by the asynchronous machine used according to the present invention can thus be adjusted on the basis of an at least approximately stationary rotor. Consequently, no rotor position sensor is required to ascertain the rotational movement of the rotor.

According to one embodiment of the present invention, the control device of the braking device is designed to receive a setpoint value for a braking force to be adjusted. Accordingly, the control device on the asynchronous machine can adjust a torque using the received setpoint value for the braking force to be adjusted. Since the torque delivered by the asynchronous machine and thus also the force which the braking element exerts on the brake pads is proportional to the magnetic flux and the slip in the asynchronous machine, the control device, assuming a quasi-stationary state for the rotor in the asynchronous machine, can easily adjust the braking force without a rotor position sensor being required for this purpose on the asynchronous machine.

According to one embodiment of the present invention, the control device is designed to receive a sensor value from a rotational speed sensor. Said rotational speed sensor can in particular detect a rotational speed of a wheel to be braked. The wheel to be braked can, for example, be mechanically coupled to a brake disc which is braked by the brake pad or the brake pads which are actuated by the braking element of the braking device. Accordingly, the control device can also be designed to receive a torque on the asynchronous machine using the sensor value received from the rotational speed sensor. Evaluating the sensor values from the rotational speed sensor allows a rotational movement of the wheel or of the brake disc to be ascertained. During the braking process, a deceleration, i.e., a reduction in the rotational speed, can thus be monitored. Accordingly, the torque delivered by the asynchronous machine can be adapted according to the ascertained rotational speed in order to exert a specified braking force. Thus, for example, a locking of the wheel can be detected very quickly by monitoring the sensor values from the rotational speed sensor. The torque delivered by the asynchronous machine can then, for example, be reduced in order to reduce the braking force and thus prevent further locking of the wheel.

According to one embodiment of the present invention, the control device is designed to adjust electrical phase currents on the asynchronous machine using the torque to be adjusted.

According to one embodiment of the electromechanical braking system of the present invention, a rotational speed sensor is provided in the electromechanical braking system. This rotational speed sensor is designed to detect a rotational speed of the brake disc or of a wheel mechanically coupled to the brake disc. Accordingly, the control device is designed to control the asynchronous machine using the detected rotational speed. In this way, a deceleration of the wheel can be monitored. The braking force can then be adapted by adapting the torque delivered by the asynchronous machine. In particular, a locking of the wheel can be detected very quickly and the braking force can then be reduced in order to release the locked wheel again.

The above embodiments and developments of the present invention can be combined with one another in any manner insofar as is reasonable. Further embodiments, developments, and implementations of the present invention also include combinations, even those not explicitly mentioned, of features of the present invention described above or in the following with regard to the exemplary embodiments. A person skilled in the art will in particular also add individual aspects as improvements or additions to the relevant basic forms of the present invention.

### BRIEF DESCRIPTION OF THE DRAWINGS

Further features and advantages of the present invention will be explained in the following with reference to the figures.

FIG. 1 is a schematic representation of an electromechanical braking system having a braking device according to one example embodiment of the present invention.

FIG. 2 is a flow chart of a method for operating an electromechanical braking system according to one example embodiment of the present invention.

### DETAILED DESCRIPTION OF EXAMPLE EMBODIMENTS

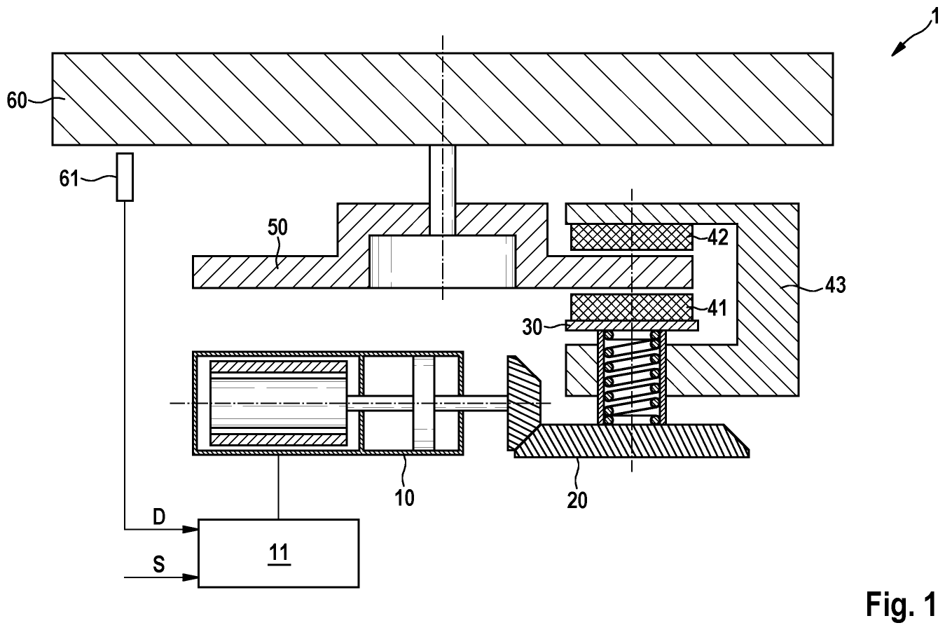

FIG. 1 is a schematic representation of an electromechanical braking system 1 according to one embodiment. The electromechanical braking system 1 comprises a brake disc 50 which is mechanically coupled to a wheel 60 via a force-fitting connection. A rotational speed sensor 61 can be provided on the wheel 60 or optionally on the brake disc 50. This rotational speed sensor 61 can monitor the rotational movement of the wheel 60 and thus also of the brake disc 50 by sensors and provide a sensor signal D corresponding to the rotational speed.

One or more brake pads 41, 42 can be pressed against the brake disc 50 to brake the rotating wheel 60. In this case, the rotation of the brake disc 50 is braked according to the force exerted by the brake pads 41, 42.

Whereas in conventional braking systems the brake pads 41, 42 are usually pressed against the brake disc 50 by means of a hydraulic system, in the electromechanical braking system shown in FIG. 1, a braking device having an electric drive is provided. The functional principle of said electric drive is explained in more detail in the following.

In order to exert a braking force of the brake pads 41, 42 onto the brake disc 50, an asynchronous machine 10 is provided in the electromechanical braking system 1, which asynchronous machine presses at least one brake pad 41 against the brake disc 50 via a transmission 20. Optionally, a mechanical component 43 can be provided which makes it possible for the force exerted by the transmission 20 to be distributed uniformly onto the two brake pads 41, 42, so that the brake disc 50 can be braked from both sides via the brake pads 41, 42. For example, the force exerted by the transmission 20 can initially act on a braking element 30 on which a brake pad 41 can be fastened.

In the idle state, i.e., when no braking force is to be exerted on the brake disc 50 by the brake pads 41, 42, only a very small distance exists between the brake pads 41, 42 and the brake disc 50. Consequently, the brake pads 41 or 42 have to be moved only very slightly to exert a braking force on the brake disc 50. This means that the axis of rotation of the asynchronous machine 10 has to rotate only very slightly too, i.e., by only a very small angle, in order to press the brake pad or brake pads 41, 42 against the brake disc 50. Due to the very small distance of the brake pads 41, 42 from the brake disc 50 in the idle state, only a very small rotational movement of the drive shaft by the asynchronous machine 10 is required, even by the transmission ratio of the transmission 20. This means that, for the below-described control of the asynchronous machine 10, an at least approximately stationary state of the drive shaft and thus of the rotor of the asynchronous machine 10 can be assumed. This is referred to below as a quasi-stationary rotor position.

To adjust a specified braking force, it is necessary to press the brake pads 41 and 42 against the brake disc 50 with a force corresponding to the specified braking force. For this purpose, the asynchronous machine 10 must provide a corresponding torque at the input of the transmission 20. The torque delivered by the asynchronous machine 10 is proportional to the magnetic flux and the slip, that is to say the speed difference between the rotor and the rotating magnetic field, in the asynchronous machine. Since, as explained above, a quasi-stationary rotor position can be assumed in the described braking system 1, it is thus possible to adjust the desired slip and thus the torque delivered by the asynchronous machine 10 solely using the frequency of the phase voltages on the asynchronous machine. It is thus possible to control the braking force without an additional rotor position sensor on the asynchronous machine 10.

The asynchronous machine 10 can be controlled, for example, by means of a control device 11. This control device 11 can provide electrical phase currents and phase voltages on the asynchronous machine 10, which are suitable for delivering the desired torque to the transmission 20 by the asynchronous machine 10.

For this purpose, a setpoint value S for a braking force can be specified on the control device 11, for example. Using this setpoint value S, the control device 11 can adjust suitable electrical currents and voltages on the asynchronous machine 10 for the braking force to be adjusted. For example, an appropriate correspondence between the specified braking force and the currents or voltages to be adjusted can be stored in a memory in the control device 11. Alternatively, it is also possible to specify the relationship between the braking force to be adjusted and the currents or voltages as a functional relationship and to calculate the respective currents or voltages using such a functional relationship according to the specified braking force. Of course, any other methods for ascertaining the currents or voltages to be adjusted according to a setpoint value S for the braking force to be adjusted are also possible.

Furthermore, it is also possible to include the rotational speed of the wheel 60 or of the brake disc 50 in the control of the asynchronous machine 10. For this purpose, for example, the sensor values D provided by the above-described rotational speed sensor 61 can be evaluated by the control device 11. For example, a conclusion about the present deceleration can be ascertained by the electromechanical braking system 1 from the change in the rotational speed, in particular a reduction in the rotational speed during the braking process. Correspondingly, according to the present change in the rotational speed and the deceleration derived therefrom, a further regulation of the torque delivered by the asynchronous machine 10 or the phase currents or voltages to be adjusted can be carried out. In this way, the electromechanical braking system 1 is able to adapt very rapidly to the braking behavior.

In particular, a locking of the wheel 60 can also be detected by evaluating the sensor signals D from the rotational speed sensor 61, for example. In such a case, i.e., when a locking wheel 60 is detected, the torque delivered by the asynchronous machine 10 and thus also the force with which the brake pads 41 and 42 act on the brake disc 50 can be reduced. As a result, the braking force can be reduced to such an extent that the wheel no longer locks. In this way, it is possible to intervene in the braking behavior very quickly, so that a vehicle with such a braking system 1 can be better controlled.

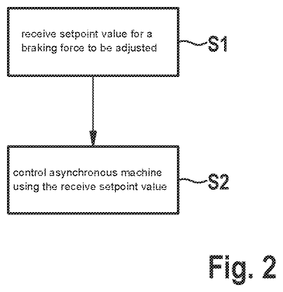

FIG. 2 is a flow chart of a method for operating an electromechanical braking system 1 according to one embodiment. In particular, this can be the above-described electromechanical braking system having an asynchronous machine 10. Accordingly, the method can comprise any of the steps already described above in connection with the electromechanical braking system 1. Analogously, the electromechanical braking system 1 described above can also comprise components which are required to implement the method described below.

In step S1, a setpoint value S for a braking force to be adjusted can be received.

Then, in step S2, the asynchronous machine 10 of the electromechanical braking system can be controlled using the received setpoint value S. The asynchronous machine 10 is controlled using a quasi-stationary rotor position of the asynchronous machine.

In addition, any suitable further parameters, for example a rotational speed of a wheel to be braked or the like, can also be included in the control of the asynchronous machine.

In summary, the present invention relates to an electromechanical braking system. The force required for the braking process is thereby provided by means of an asynchronous machine. The asynchronous machine and in particular the torque delivered by the asynchronous machine is adjusted using a quasi-stationary rotor position for the rotor of the asynchronous machine.

1.-7. (canceled)

8. A braking device, comprising:
a braking element configured to exert a force on a brake pad;
an asynchronous machine;
a transmission configured to mechanically couple a drive shaft of the asynchronous machine to the braking element; and
a control device configured to control the asynchronous machine using a quasi-stationary rotor position of the asynchronous machine.

9. The braking device according to claim 8, wherein the control device is configured to receive a setpoint value for a braking force to be adjusted and to adjust a torque on the asynchronous machine using the received setpoint value for the braking force to be adjusted.

10. The braking device according to claim 8, wherein the control device is configured to receive a sensor value from a rotational speed sensor which detects a rotational speed of a wheel to be braked, and the control device is configured to adjust a torque on the asynchronous machine using the received sensor value.

11. The braking device according to claim 8, wherein the control device is configured to adjust electrical phase currents on the asynchronous machine using a specified torque.

12. An electromechanical braking system, comprising:
a braking device including:
a braking element configured to exert a force on a brake pad,
an asynchronous machine,
a transmission configured to mechanically couple a drive shaft of the asynchronous machine to the braking element, and
a control device configured to control the asynchronous machine using a quasi-stationary rotor position of the asynchronous machine;
a brake disc; and
the brake pad, wherein the brake pad is configured to be pressed against the brake disc by the braking device.

13. The electromechanical braking system according to claim 12, further comprising:
a rotational speed sensor configured to detect a rotational speed of the brake disc or of a wheel mechanically coupled to the brake disc, wherein the control device of the braking device is configured to control the asynchronous machine using the detected rotational speed.

14. A method for operating an electromechanical braking system which is controlled by an asynchronous machine, wherein the method comprises the following steps:
receiving a setpoint value for a braking force to be adjusted; and
controlling the asynchronous machine using the setpoint value for the braking force to be adjusted, and a quasi-stationary rotor position of the asynchronous machine.
